(19) United States
(12) Patent Application Publication
(10) Pub. No.: US 2020/0273358 A1
(43) Pub. Date: Aug. 27, 2020

(54) Educational Device

(71) Applicant: SARIT GVILI, Hadera (IL)

(72) Inventor: SARIT GVILI, Hadera (IL)

(21) Appl. No.: 16/650,951

(22) PCT Filed: Sep. 20, 2018
(86) PCT No.: PCT/IL2018/051064

§ 371 Date: Mar. 26, 2020

Related U.S. Application Data
(60) Provisional application No. 62/563,659, filed on Sep. 27, 2017.

(51) Int. Cl. G09B 5/06; G09B 19/04; G09B 21/00; A63H 13/16

(52) U.S. Cl. CPC G09B 5/06; A63H 13/16; G09B 21/007; G09B 19/04

(57) ABSTRACT

Educational or learning devices for maintaining an individual's attention and concentration, combine and perform multiple functions and technologies simultaneously.

### CROSS-REFERENCES TO RELATED APPLICATIONS

This application is related to and claims priority from commonly owned US Provisional Patent Applications: US Provisional Patent Application Ser. No. 62/563,659, entitled: Educational and Therapeutic Method, Product and Game, filed on Sep. 27, 2017, the disclosure of which is incorporated by reference in its entirety herein.

### TECHNICAL FIELD

The present invention is directed educational devices, including toys and games.

### BACKGROUND OF THE INVENTION

The world of education has been a major part in human life for centuries. Since the beginning of time, and for thousands of years, the learning process was handed down, from father to son at first and from private tutor to student later on. Years passed, and as the human race and within it a myriad of cultures continued to develop all over the world, mankind came to the conclusion that one single teacher could teach a number of students simultaneously, in groups.

The introduction of group studies also presented a problem: as the number of students per group has increased, studying in a group became complicated. It became difficult for the students to focus and pay attention.

Additionally, attention deficit and hyperactivity have become major contemporary issues, adding complications to maintain students' attention and concentration. The solution to maintaining attention and concentration of students and other individuals remains elusive.

### SUMMARY OF THE INVENTION

The present invention provides devices, to maintain an individual's attention and concentration, which combines and performs multiple functions and technologies, contemporaneously, including simultaneously. The devices are personal devices, small and compact, so as to be transportable. Embodiments of the present invention provide devices which integrate combinations of visual images, graphic displays, audio, lights and tactile stimulations, such as vibrations.

Embodiments of the invention are directed to an educational device. The device comprises: a body. The body includes: at least one push button displaying first indicia; at least one graphic display configured for moving from a first position inside of the body to a second position outside of the body in response to activation of the push button, and including second indicia corresponding to the first indicia of the push button; and, an audio system responsive to the at least one push button, by providing audio corresponding to the first indicia and the second indicia, when the at least one push button is depressed.

Optionally, the first indicia and the second indicia include one or more of letters, numbers, characters, terms, symbols, and graphics.

Optionally, the first indicia is in relief.

Optionally, the relief is at least one of raised from the surface of the pushbutton, indented into the surface of the push button, and combinations thereof.

Optionally, the characters include braille.

Optionally, the at least one push button includes a removably attachable plate supporting the first indicia.

Optionally, the graphic display includes a display portion for supporting the second indicia and an arm, the arm pivotally mounted in the body and the graphic display is loaded in the body in a spring like manner so as to rotate out of the body in response to the depression of the at least one push button.

Optionally, the display portion includes a removably attachable plate supporting the second indicia.

Optionally, the audio system in electronic and/or data communication with the at least one push button.

Optionally, the device additionally comprises a USB connection configured for allowing a user to upload data of characters or terms into the educational device.

Embodiments of the invention are directed to a method for teaching sound pronunciation. The method comprises: obtaining a device. The device comprises: at least one push button displaying first indicia; at least one graphic display configured for moving from a first position inside of the body to a second position outside of the body in response to activation of the push button, and including second indicia corresponding to the first indicia of the push button; and, an audio system responsive to the at least one push button, by providing audio corresponding to the first indicia and the second indicia, when the at least one push button is depressed. The at least one push button is depressed to: 1) cause movement of the at least one graphic display from the first position to the second position; and, play audio corresponding to the first indicia and the second indicia.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1A is a perspective view of an embodiment of a device in an initial position;

FIG. 1B is a perspective view of the device of FIG. 1A in an extended position;

FIG. 2 is a cross-section view of the device of FIG. 1A;

FIG. 3 is a block diagram of a controller for the device of FIG. 1A;

FIG. 4 is an illustration of the device of FIG. 1A in an operational mode;

FIGS. 5A and 5B are perspective views of another embodiment of the device of the invention;

FIG. 6 is a perspective view of another embodiment of the device of the invention in an extended position; and,

FIG. 7 is a perspective view of another embodiment of the device of the invention in an extended position.

### DETAILED DESCRIPTION OF THE DRAWINGS

The present invention is not limited in its application to the details of construction and the arrangement of the components set forth in the following description. The invention is capable of other embodiments, or of being practiced or carried out in various ways. Also, it is to be understood that the phraseology and terminology employed herein is for the purpose of description and should not be regarded as limiting.

The present invention provides a hand-size educational toy that promotes concentration and attention in users by stimulating their senses during its operation. The present invention combines any of: visual images, graphic displays, audio, lights and tactile stimulations, such as vibrations, to simultaneously and coordinately stimulate the visual sense, the sense of touch and the sense of hearing of a user. The present invention provides a useful tool for handling and improving different conditions, such as, language acquisition, Attention Deficit Hyperactivity Disorder (ADHD), dyslexia, and other attention and concentration affecting conditions.

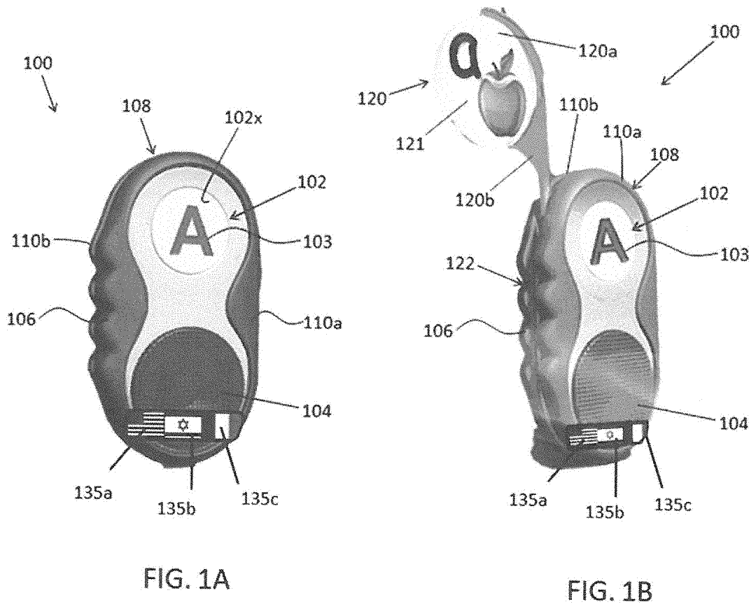

FIG. 1A shows the device 100 of the invention as, for example, an educational toy. The device 100 is in an initial position. The device 100 includes a button 102, which activates one or more functionalities. The button 102, for example, includes a graphic 103 or other indicia (letters, numbers, characters, terms, symbols, graphics, and/or combinations thereof), typically related or corresponding to the graphic display 120 (FIG. 1B), and/or the audio, lights and tactile stimulations, produced by the device 100. The graphic 103 (for example the indicia “A”) may be in relief, typically raised from the surface 102x of the button 102, or indented into the surface 102x of the button 102, and on one or both sides of the display portion 120a. The device 100 also, for example, includes a speaker/microphone 104, which receives audio input, such as user speech, e.g., commands, responses and the like. The device 100 is dimensioned, for example, to be hand held and includes a gripping portion 106.

The device 100, for example, is a body 108 formed of two polymeric shells 110a, 110b, fit together by a mechanical fit, e.g., snap (friction) fit, welds, or combinations thereof, a chemical fit, e.g., adhesives, or combinations thereof. The shells 110a, 110b, when fitted together form a hollow cavity to house electronics and other operational components for the device 100.

Alternately, one or both of the shells may be replaced with other shells of various colors, textures, forms, and the like. For example, one or more shells shaped like an animal may be used, should an animal be taught by the device 100.

Turning also to FIG. 1B, the device 100 is shown with a graphic display 120 in an extended position, where activation of the push button 102, has released the graphic display 120 and caused it to move out of the body 108, from an initial retracted position, to the extended and fixed position. The graphic display 120 includes a display portion or section 120a, which supports indicia 121 (letters, numbers, characters, terms, symbols, graphics, and/or combinations thereof), with an arm 120b protruding therefrom, the arm 120b at its end, pivotally mounted in the body 108. The indicia 121 typically correspond to the graphic 103 on the push button 102. The graphic display 120 is typically fitted in a slot 122 between the shells 110a, 110b of the body 108, and is spring loaded, such that once activated (e.g., by depression of the button 102), the display 120 moves outward from the slot 122 along an arc 134, to the extended and fixed position, as shown. The audio for the speaker is, for example, programmed in a preselected language.

The device 100, optionally includes language buttons 135a-135c (the corresponding language shown by the national flag), such as English (USA) 135a, Hebrew (Israel) 135b, and French (France) 157c. When the buttons 135a-135c are depressed, the audio will be in the corresponding language.

Alternately, buttons 135a-135c may be other indicia, such as colors, letters, animals, with corresponding graphic displays 120a and audio, to teach these colors, letters, animals, and the like, to the subject using the device.

The device 100 is such that the button 102 and/or the graphic display 120 may include display screens, where the graphics and other visual indicia can be varied, for example, to any desired letter, word, phrase, or the like. The letter, word or phrase may be preprogrammed into the device 100 and selected manually on the device 100 by a user, or programmed and selected via a universal serial bus (USB), as below, or on-line link, when the device 100 supports a network connection.

While the body 108 is shown with the button 102, speaker/microphone 104, and optional language or other buttons 135a-135c on one side, these elements 102, 104, 135a-135c may be on both sides of the body 108 of the device.

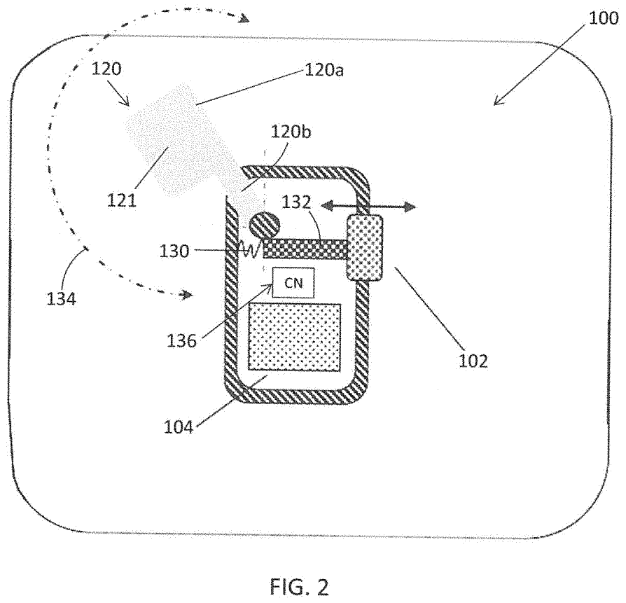

FIG. 2 is a cross-section view of the device 100. The device 100 includes the push button 102, which is spring loaded, for example, via a retractable spring 130. The retractable spring 130, once activated by the push button 102, moves a member 132, that releases the graphic display 120. This release causes the pivotally mounted arm 120b to move rotationally (e.g., clockwise), along an arc 134, to a stop surface, taking the display portion 120a with it, and out of the slot 122, to the extended position. The graphic display 120 remains in this extended position until moved along the arc (e.g., counterclockwise), so as to be moved back into the body 108, into the initial (retracted) position. The retractable spring 130 and member 132 are configured to hold the graphic display 120 in this initial or retracted position, inside the body 108, until released by the pushing of the button 102.

The push button 102 displays the indicia 103, e.g., the letter, number, character, term, symbol graphic, and/or combination thereof, that the user is learning. The character or term can be a letter, a number, a word, a sentence or a combination thereof. The push button 102 and the graphic display 120 may have the presented character or term minted on them or may display the desired character or term using different electrical displays, such as, visual screen, graphic screen, touch screen, and the like.

The character, term or other graphic, i.e., the indicia 121, on the graphic display 120 may be presented using different writing systems. For example, the writing may be, braille, making the device 100 accessible for blind users.

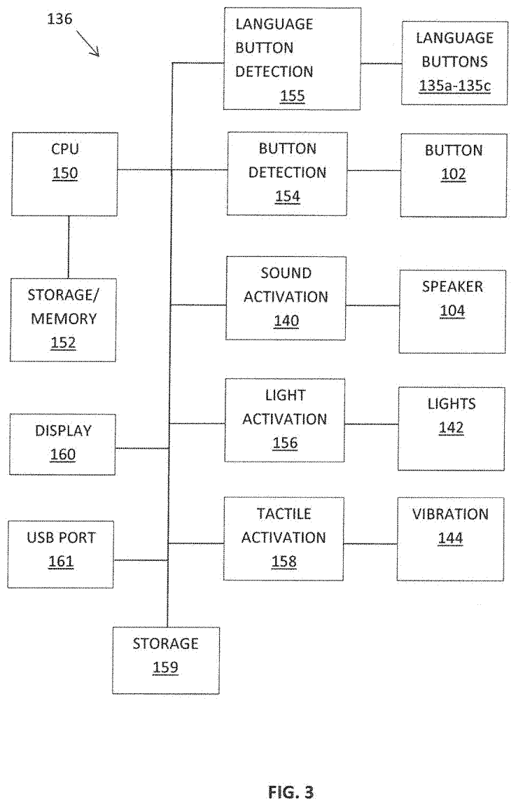

The device 100 also includes a speaker 104, linked to a sound activator 140 (FIG. 3), as well as a controller (CN) 136. The device 100 may also include lights 142 (FIG. 3), and, vibration generating mechanisms 144 (FIG. 3). The speaker 104 typically activates when the button 102 is depressed. The audio of the speaker is, for example, coordinated with the indicia 103 of the button and the indicia 121 of the display portion 120a, and should a language button 135a-135c be present on the device 100, the audio plays in the selected language. The CPU 150 may also be programmed for a default language, such as English, should none of the language buttons 135a-135c be pressed.

FIG. 3 shows the controller 136, which is processor based, and controlled by a central processing unit (CPU) 150. Programs for running the CPU 150, as well as programs for causing sounds, lights and/or vibrations, in response to and contemporaneous with a button press and graphic display release are stored in the storage/memory 152. The CPU 150 is in electronic and/or data communication with a button detection sensor 154 (electronically linked to the button 102), a sound activation module 140 (electronically linked to the speaker 102), a language button detection sensor 155, a light activation module 156 (electronically linked to one or more lights 142), and a tactile activation module 158 (electronically linked to a vibration mechanism 144, for vibrating the body 108 if programmed by the CPU 150 to do so). The CPU 150 is also in in electronic and/or data communication with data storage 159, from which various audio, e.g., sounds, are stored, which correspond to the first and second indicia. There is also a display module 160, which creates and sends messages, e.g., typically related to the graphic 103 on the push button 102, on a display screen on the device 100.

Alternately, the device may also include a USB (Universal Serial Bus) connection port 161, which via a USB cable can be attached, so that data is transferred to the storage media 159, for use by the controller, as audio in multiple languages, and other programs for the CPU 150.

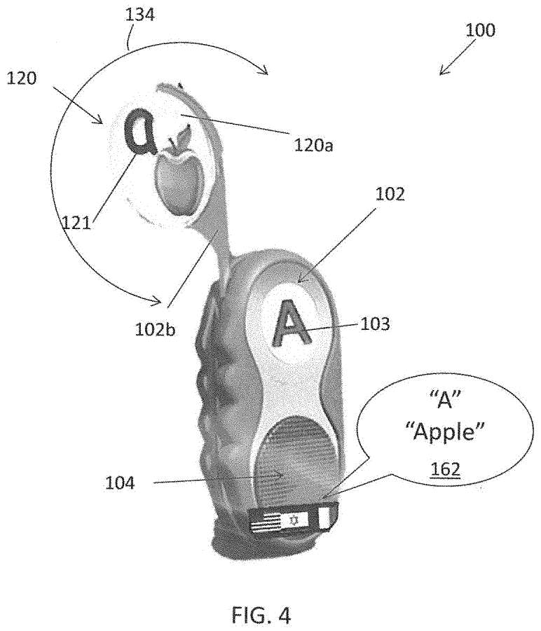

FIG.4 is an illustration of the device 100 in operation. When the button 102 is pressed by a user, the graphic display 120 is released from the body 108. This button press is detected by the button detector 154, which signals the CPU 150 of this event. The CPU 150 responds by activating the sound activation module 140, which in turn, releases a prerecorded and preprogrammed sound 162, such as “APPLE”, in response to the graphic 121 of the letter “A” on the graphic display 120 and/or the graphic 103 of the push button 1021n one embodiment, the educational toy may include more than one push button. Each push button is connected to its own Pop-up graphic display 120, which displays different characters, terms and/or graphics, as presented in FIG. 3. Should a language button 135a-135c be present, the user would push the English Language button 135a, so that “A” and “Apple” are the audio for the button 102 and graphic display 120.

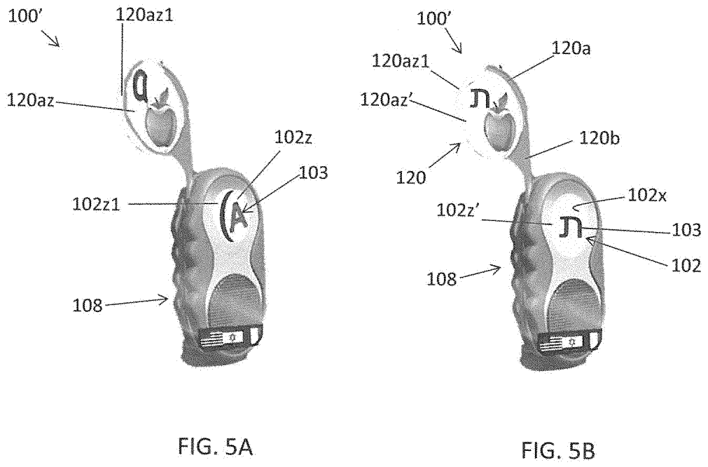

FIGS. 5A and 5B show an alternate apparatus 100′, where the button 102 and display portion 120a include a plates 102z, 120az on which the indicia 103, 121 reside, which are removable from bases 102z1, 120az1, and are replaceable by new plates 102z′ and 120az′ with corresponding indicia. The plates 102z, 102z′, 120az, 120az′ typically attach to the bases 102z1 and 120az1 in a removably attachable manner, such as by friction fits, such as snap fits and the like. Should a more permanent attachment be desired, the plates 102z, 102z′, 120az, 120az′ may be attached to the bases 102z1 and 120az1, by adhesives and the like.

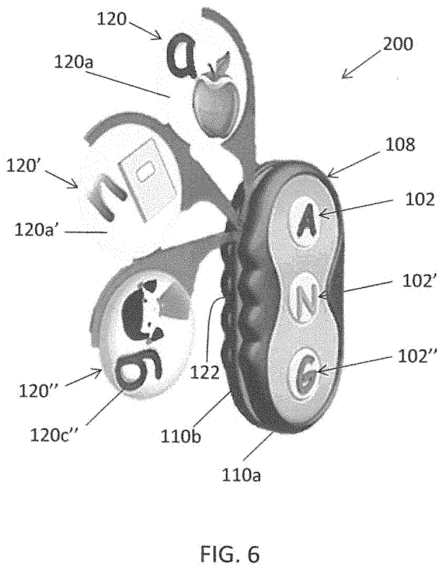

FIG. 6 shows another embodiment device 200, which is similar in construction and operation to device 100, as detailed above, except where indicated. The device 200 is such that it has multiple push buttons 102, 102′, 102″, each of which corresponds to a graphic display 120, 120′, 120″ (shown in the extended position), which displays (in the display portions 120a, 120a′, 120a″) the desired character or term according to the push button 102a-102c that was pressed.

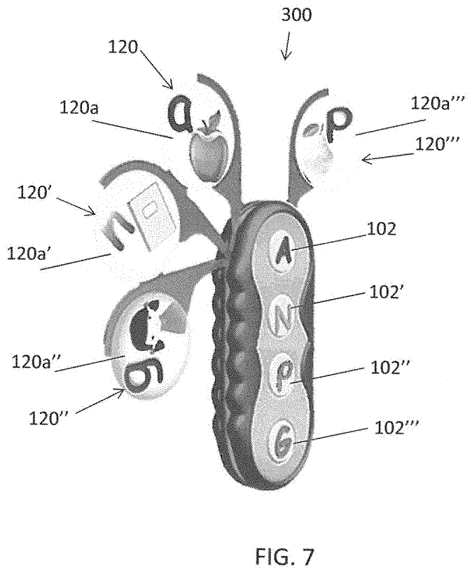

FIG. 7 shows another embodiment device 300, which is similar in construction and operation to device 100, as detailed above, except where indicated. The device 200 is such that it has multiple push buttons 102, 102′, 102″, 102′″, each of which corresponds to a graphic display 120, 120′, 120″ (shown in the extended position), one side of the body 108, and one or more graphic displays 120″', on the other side of the body, which displays (in the display portions 120a, 120a′, 120a″, 120a′″) the desired character or term according to the push button 102, 102′, 102″, 102′″, that was pressed (depressed).

In other embodiments, the devices 100, 200 the graphic display 120 may also include an image of an item that its name starts with the character displayed. Once the graphic display 120 is out from the body 108, the audio system pronounces the character and the name of the item displayed.

While the invention has been described with respect to a limited number of embodiments, it will be appreciated that many variations, modifications and other applications of the invention may be made. Therefore, the claimed invention as recited in the claims that follow is not limited to the embodiments described herein.

1. An educational device comprising:
a body including:
at least one push button displaying first indicia;
at least one graphic display configured for moving from a first position inside of the body to a second position outside of the body in response to activation of the push button, and including second indicia corresponding to the first indicia of the push button; and,
an audio system responsive to the at least one push button, by providing audio corresponding to the first indicia and the second indicia, when the at least one push button is depressed.

2. The educational device of claim 1, wherein the first indicia and the second indicia include one or more of letters, numbers, characters, terms, symbols, and graphics.

3. The educational device of claim 2, wherein the first indicia is in relief.

4. The educational device of claim 3, wherein the relief is at least one of raised from the surface of the pushbutton, indented into the surface of the push button, and combinations thereof.

5. The educational device of claim 2, wherein the characters include braille.

6. The educational device of claim 1, wherein the at least one push button includes a removably attachable plate supporting the first indicia.

7. The educational device of claim 1, wherein the graphic display includes a display portion for supporting the second indicia and an arm, the arm pivotally mounted in the body and the graphic display is loaded in the body in a spring like manner so as to rotate out of the body in response to the depression of the at least one push button.

8. The educational device of claim 7, wherein the display portion includes a removably attachable plate supporting the second indicia.

9. The educational device of claim 1, wherein the audio system in electronic and/or data communication with the at least one push button.

10. The educational device of claim 1, additionally comprising a USB connection configured for allowing a user to upload data of characters or terms into the educational device.

11. A method for teaching sound pronunciation comprising:
obtaining a device comprising:
at least one push button displaying first indicia;
at least one graphic display configured for moving from a first position inside of the body to a second position outside of the body in response to activation of the push button, and including second indicia corresponding to the first indicia of the push button; and,
an audio system responsive to the at least one push button, by providing audio corresponding to the first indicia and the second indicia, when the at least one push button is depressed; and,
depressing the at least one push button to: 1) cause movement of the at least one graphic display from the first position to the second position; and, play audio corresponding to the first indicia and the second indicia.
